(19) United States
(12) Patent Application Publication
(10) Pub. No.: US 2023/0135508 A1
(43) Pub. Date: May 4, 2023

(54) Brake Actuator For Human Mobility Device

(71) Applicant: Douglas G. Robins, Hermosa Beach, CA (US)

(72) Inventor: Douglas G. Robins, Hermosa Beach, CA (US)

(21) Appl. No.: 18/052,133

(22) Filed: Nov. 2, 2022

Related U.S. Application Data
(60) Provisional application No. 63/263,428, filed on Nov. 2, 2021.

(51) Int. Cl. A61G 5/10; A61G 5/02; F16D 65/28; F16C 1/18

(52) U.S. Cl. CPC A61G 5/1035; A61G 5/025; F16D 65/28; F16C 1/18; F16D 2121/14

(57) ABSTRACT

A brake actuation mechanism for a human powered mobility device, such as a lever drive wheelchair, is described. The brake actuation mechanism may include an actuator member positioned at or near an end of a lever drive such that the actuator member may be actuated or engaged by a user's thumb when grasping a lever of the human mobility device. Since the lever may drive motion of human mobility device, the user may maintain a firm grip on the lever while also manipulating or engaging the actuator member.

### RELATED APPLICATIONS

This application claims benefit of and priority to U.S. Provisional Application Ser. No. 63/263,428 filed Nov. 2, 2021 entitled Brake Actuators For Lever Drive Wheelchairs And Other Manually Propelled Mobility Devices, which is hereby incorporated herein by reference in its entirety.

### BACKGROUND OF THE INVENTION

### Novelty Of A Thumb Actuated Lever Drive Wheelchair Brake Actuator

This instant novel design, is for a wheelchair brake actuation system, which uses one's thumbs for actuation. This thumb actuation system, can also be used for other manually propelled human conveyances, such as bicycles. It's novelty includes that, unlike other manual brake actuators, it allows the user of such conveyance devices to maintain a safe, tight grip, on the handles with all fingers, while also, at the same time, actuating the brakes using one's thumbs.

This design is novel and unique, especially in that, all of the brake actuators, known to Applicant for items such as Lever Drive Wheelchairs, and other manual human mobility devices such as bicycles, require add-ons to the handle bars, levers etc.. The only exception known to Applicant is on a Lever Drive Wheelchair (FIG. 5) where the brake actuator is part of the lever itself. However, this design has been shown to not function practically, as the handle must be rotated down at the same time as moving forward and backward to propel the wheelchair.

The use of these add-ons requires the user to substantially loosen the fingers' grip on the handles or move the fingers of one's hands, but substantially, off of the handles to actuate the brakes. See for instance Prior Art FIG. 4, Prior Art FIG. 7, and the typical lever actuated bicycle brake which is similar to FIG. 21. This loss of secure grip, considerably compromises steering and operational control, as well as compromises the ability of the user to stay safely and securely seated. Such loss of control is especially dangerous while the wheelchair or, for instance, a mountain bike, is going down a slope at perhaps significant speed.

Of further note as to the novelty and uniqueness of applicant's design, is the use of a push button plunger as an actuator, situated at the end of the handle of a Lever Drive Wheelchair or other mobility device such as a bicycle. It allows for all fingers to maintain a secure grasp the handles with one's fingers, while maximum force can still be exerted by one's thumb. FIGS. 6A, 6B & 6C.

This ability to apply maximum thumb force occurs because of the biomechanics of the thumb. When one's hand is securely wrapped around a handle of perhaps one inch in diameter, plus or minus, maximal force by the thumb can only occur when the thumb is situated at or very near the centerline of the handle, and moves/pushes in/across, laterally along the central axis of said handle, as in Applicant's design. FIGS. 6A, 6B & 6C.

This thumb actuated, brake actuator, can be incorporated into the handles of various Lever Drive Wheelchairs, including those with telescoping levers, or as a total handle bar unit for something like a bicycle, but it cannot be merely an add on to existing Lever Drive Wheelchairs, or a bicycle This is because the mechanism must be incorporated into the handle itself. Reasons include that the thumb must be able to be positioned at or very near the center of the push button, FIGS. 6A, 6B 6C, Axis 15, so that the thumb can move laterally along the central axis of the handle, (FIGS. 6A, 6B & 6C) to allow maximum thumb force.

Note that an add-on such as depicted in Prior Art FIG. 8, does not allow for maximum thumb force to be exerted, due to the biomechanics of the thumb. A thumb can barely move laterally along the handle if positioned above the handle and if positioned below the handle the thumb cannot exert much force laterally along the handle. FIGS. 9A & 9B demonstrate these biomechanically unacceptable thumb positions and related movements along Axis 19 and Axis 20.

The device in Prior Art FIG. 8 (U.S. Pat. No. 8,256,323B2) looks good on paper. However, the thumb is being asked to move laterally on Axis 15, well below the bottom of the handle. (Axis 15′″) However, due to the biomechanics of the thumb, very little thumb force can be applied in that direction. This design would certainly not provide enough thumb force to actuate a wheelchair brake or a bicycle brake, while one tries to maintain one's fingers tightly around the handle.

The only way to get maximum thumb force, and still be able to maintain a tight grasp on the handles with one's fingers, is via Applicant's design, as depicted in FIGS. 6A, 6B & 6C.

### Description Of Manual Lever Drive Wheelchairs And Conventional Manual Wheelchairs

A “Lever Drive Wheelchair” is a type of manually propelled wheelchair (FIG. 2 item 1, person in lever drive wheelchair). However, unlike a conventional manual wheelchair (FIG. 1 item 1, person in conventional wheelchair) vertical levers are provided on both sides of the wheelchair FIG. 2, 5, and are moved forwards and backwards 5′ and FIG. 3, 5′ in what could be described as a rowing type motion via the handles 12. This rotates the wheels FIG. 2, 6, 6′ & FIG. 3 6′, to manually propel the wheelchair. (FIGS. 2 & 3) This movement propels the wheelchair, either forward or backwards depending upon the gear selected. A neutral gear can also be provided. The levers are mechanically connected to the drive wheels via a transmission. (FIG. 2, 7).

Note that a Lever Drive Wheelchair can have the drive wheels either in the front, as in FIG. 2, or can be at the rear, much like a conventional wheelchair (FIG. 1).

Existing braking is currently provided by various techniques, most notable is the use of braking systems typically used for bicycles (Prior Art FIG. 7, Prior Art FIG. 4) This usually is an add-on actuation lever of some sort on the handle of each lever assembly as an actuator, and a pull cord or hydraulic line leading to a caliper or band type brake on each wheel. Note that the user's fingers must be released from a safe grip on the handle, in order to reach the brake actuation lever with those same fingers.

For instance, for Lever Drive Wheelchair, Prior Art FIG. 7 (U.S. Pat. No. 9,010,786B1), the lever 5, has a handle attached 12, to move the lever forward and backward to propel the wheelchair. However, to actuate the brake, the fingers of the hand must be removed from the handle to actuate the brake lever 16. This is not a safe design or a design which lends itself to efficient and practical use.

A typical conventional manual wheelchair as in FIG. 1, is propelled manually when one grasps the wheel or wheel extension, called a “Push Ring”, “Push Rim”, “Hand Ring”, Handrim etc. 3, and rotates it, it either forward or backward. This also rotates the wheelchair drive wheel 4 which is attached to it. Braking is accomplished by grasping the Push Rim, 3 to impede the rotation of the drive wheel by friction of the hand on the Push Rim. Tightly squeezing the Push Rim stops its rotation entirely, and fully stops the wheelchair.

### Necessity For Precise Differential Braking Or Steering And Control Of Manual Lever Drive Wheelchairs And Conventional Manual Propelled Wheelchairs

“Piloting” a manual wheelchair is not as easy as one may think! For instance, it takes learned coordination to be able to propel a wheelchair efficiently, and, importantly, safely.

To be able to safely and efficiently pilot either a Lever Drive Wheelchair or a conventional wheelchair, it is critical that directional control and speed control are maintained. This is particularly critical when a wheelchair user heads down a slope. If directional control and speed are not precisely controlled, the wheelchair can tip over sideways, or run wild off the desired direction and into harm's way, or into terrain which can flip over the wheelchair and its occupant.

Steering and speed control for both Lever Drive Wheelchairs as well as conventional manual drive wheelchairs, is accomplished via what can be called differential propulsion and braking of the right side vs the left side wheels. This is further described below.

As to bicycles, the criticality of both directional and speed control, of course, applies as well. This is particularly true for mountain bikes, which are often driven at terrific speeds, down rough/bumpy and winding trails. It is therefore desired that the cyclist be able to maintain a tight grip on the handles, at all times, while still being able to use the brakes. Unfortunately, the many hundreds of versions of add-on bicycle brake actuators, do not provide adequately for this. See for instance Prior Art FIG. 4, which is a typical, add-on, bicycle style hand brake actuator.

There may be some add-on bicycle brake actuators which could be pressed with a thumb. Perhaps similar to that depicted in FIG. 20. There, thumb forces 45 are applied to a trigger type mechanism which rotates the trigger in direction 46. This pulls the brake cord 30 in direction 28′ with force 45′. However, because the force is lateral in the direction parallel to the handle but below the level of the handle, again, because of the biomechanics of the thumb, very little force can be applied to actuate a brake, without the undesirable loosening or removing fingers from the handle.

Applicant is unaware of an existing braking system, such as proposed herein, which can accomplish the ability to maintain a tight grip on the handles, at all times, while still being able to apply significant thumb force, to activate the brakes.

### Differential Left-Right Side Propelling And Braking

Directional control of both lever drive and conventional wheelchairs is accomplished by a combination of very subtle changes in push movements in combination with subtle changes in braking, both of which must be done almost instantaneously. This is because either type of wheelchair can move off of the desired path very quickly, especially if moving quickly.

These almost instantaneously changes in the amount of pushing and braking is something any wheelchair user can attest to.

However, they may have been piloting their chair for so long—they don't even realize the almost instantaneous adjustments to pushing and braking they do without even thinking about it.

Differential propelling/pushing and braking obviously means that to go more to the right, one moves/rotates/pushes on the left side wheels more than the right and can add braking as well to the right side. To go more to the left, one moves/rotates/pushes more on the right side wheels and can add braking to the left wheel. Again, these differential left and right side adjustments are made nearly instantaneously, and very subtlety, to keep the wheelchair traveling in the desired direction.

### Novelty Of—And Importance Of The Thumb Actuated Brake Actuator For A Lever Drive Wheelchair

Simply stated, the only way to accomplish the above ability, to allow the Lever Drive Wheelchair user to maintain a tight grip on the handle FIG. 2, 12 with all fingers of the hand 14, while still being able to use the brakes, is with a thumb actuated brake.

More particularly, a thumb operated brake where the actuator button/plunger FIG. 6A, 6B 7 6C, 17 is positioned so as to move in and out along axis 15, so that thumb forces 15′, of the end of the thumb 11 move along axis 15. With the “end of the thumb”, meaning approximately between the tip of the thumb and the and the first thumb joint called the interphalangeal (IP) thumb joint.

The importance of the placement and movement of the thumb is demonstrated in FIGS. 9A, 9B & 10.

In FIG. 9A the thumb 11 of the hand 14, is positioned above, not only the plunger button 17, but also the handle 12. In this position, if the thumb was required to push something, it would have to move above and parallel to the handle 12, along axis 19. As can be seen, this requires the hand and fingers to raise well up off the handle 12, as shown by distance 19′. In this configuration, there is absolutely no way to maintain the fingers in a tight grip on the handle 12.

In FIG. 9B the thumb 11 is positioned below not only the plunger button 17, but also the handle 12. In this configuration, the fingers of the hand 14, can maintain a tight grip on the handle 12. However, the biomechanics of the hand and thumb joints is such that the thumb cannot apply much force parallel to the handle, along the axis 20. This is the problem with the design in, for instance the add-on, thumb actuated device depicted in Prior Art FIG. 8. (U.S. Pat. No. 8,256,323B2).

In FIG. 8, the add-on device is clamped on to a tube via item 13. The hand 14, grasps the handle 12, with all fingers. However, the thumb 11, must be positioned well below the axis of the bottom of the handle, axis 15′″, in order to push the “button” 15 on the lever arm along axis 15′ with the thumb force 15″ being directed along axis 15′, where as mentioned, the thumb can apply very little force due to the biomechanics of the thumb.

Note that item 18 is not a button, it is some sort of a stop to prevent the hand from slipping off the handle 12. Although as drawn, it does not depict this very well at all.

Some small deviation from applying thumb force exactly on the center axis of the wheelchair handle can be acceptable. FIG. 10 demonstrates that deviation of applying forces from the center axis 15 can be slightly above along axis 22′ with a maximum angle of about 10 degrees above the center axis 15, angle 22 or about 20 degrees below the center axis 15, angle 23 along axis 23′ allowing, in both cases, the fingers of the had 14, to maintain a tight grip on the handle 12. Again, these are limitations imposed by the nature of the biomechanics of the thumb.

The plunger 21, is shown at an angle for the thumb 11 to push on it. This embodiment while possible, is not optimal, as the mechanism inside the handle may be difficult to design and construct.

As mentioned above, there may be add-on brake actuators for bicycles, which clamp on the handle bars, which function similar to what is depicted in FIG. 20. However, such devices are suboptimal in that little force 45, could be applied on the “trigger” without releasing a firm grip on the handle 12. As such, this type of brake would not function well for a Lever Drive Wheelchair where differential pushing and braking must be able to occur in fractions of a second, as further described below. And it would be dangerous to have one's hand not able to tightly grip the handle of the Lever Drive Wheelchair at all times during propulsion, or gliding down a slope.

### Practical Need For Applicant's Braking System For A Manual Lever Drive Wheelchair

Lever Drive Wheelchairs, such as described in Applicant's prior Patent U.S. Pat. No. 9,770,376 (See FIG. 2) make it much easier to propel oneself, particularly over rough terrain, uphill, on carpets and on gravel or grass. Such designs also help tremendously in mitigating, or eliminating, shoulder injuries, which are otherwise definitively linked to the use of conventional wheelchairs and most often eventually lead to shoulder surgeries to repair one's rotator cuff.

Applicant believes acceptance of Lever Drive Wheelchairs has been hindered, because efficient and intuitive braking systems have not been available.

Thus, for a Lever Drive Wheelchair to be viable for use, and thus to be marketable, there must be a braking system which allows the user to both maintain the ability to use the levers for differential pushing on the left and right levers and at the same time, use differential braking on the left or right—again all at the same time.

Applicant's novel design for a thumb actuated brake actuator, as described herein, provides for this unique braking feature.

It should be noted that this unique brake actuator, can also be utilized for other types of wheeled mobility devices, both manually propelled, such as a bicycle and also powered wheeled mobility devices.

### SUMMARY OF THE INVENTION

The present specification is generally directed to a brake actuation mechanism for a human powered mobility device. The brake actuation mechanism may include an actuator member positioned at or near an end of a lever drive such that the actuator member may be actuated or engaged by a user's thumb when grasping a lever of the human mobility device. Since the lever may drive motion of human mobility device, the user may maintain a firm grip on the lever while also manipulating or engaging the actuator member. Put another way, the user does not need to remove or even necessarily adjust their grip on the lever to engage the brake actuation mechanism. In many circumstances, this may allow for safer usage of the human mobility device.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which.

FIG. 1 is a view of a standard/conventional wheelchair.

FIG. 2 is a view of a lever drive wheelchair.

FIG. 3 is a view of a lever and handle and transmission of a lever drive wheelchair.

FIG. 4 is a view of a prior art brake actuator, excerpted from U.S. Pat. No. 5,950,772.

FIG. 5 is a view of a prior art lever and handle which also functions as a brake actuator and transmission of a lever drive wheelchair, excerpted from U.S. Pat. No. 8,152,188B2.

FIG. 6A is a view of an example of a thumb actuated, brake actuator member.

FIG. 6B is a view of an example of a thumb actuated, brake actuator member.

FIG. 6C is a view of an example of a thumb actuated, brake actuator member.

FIG. 7 is a view of a prior art lever drive wheelchair showing the brake actuator, excerpted from U.S. Pat. No. 9,010,786B1.

FIG. 8 is a view of a prior art thumb actuated device, excerpted from U.S. Pat. No. 8,256,323B2.

FIG. 9A is a view of a thumb position above a handle.

FIG. 9B is a view of a thumb position below a handle.

FIG. 10 is a view of an example thumb actuated brake actuator.

FIG. 11 is a cross sectional view of a mechanical brake actuator mechanism.

FIG. 12 is a cross sectional view of a mechanical brake actuator mechanism.

FIG. 13 is a cross sectional view of a hydraulic brake actuator mechanism.

FIG. 14 is a view of a brake actuator mechanism.

FIG. 15 is a view of a brake actuator mechanism.

FIG. 16 is a view of a prior art brake actuator mechanism.

FIG. 17A is a cross sectional view of a brake actuator mechanism.

FIG. 17B is a cross sectional view of a brake actuator mechanism.

FIG. 18A is a cross sectional view of a brake actuator mechanism.

FIG. 18B is a cross sectional view of a brake actuator mechanism.

FIG. 19 is a cross sectional view of a brake actuator mechanism.

FIG. 20 is a schematic view of a brake actuator mechanism.

FIG. 21 is a cross sectional view of a brake actuator mechanism.

FIG. 22 is a schematic view of a rack and pinion mechanical brake actuator mechanism.

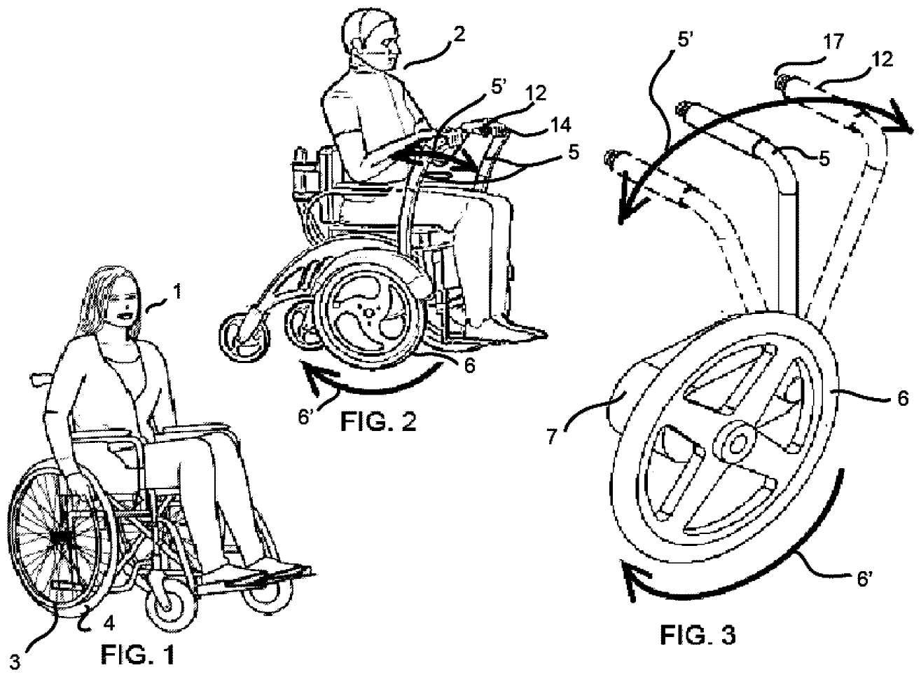

### DETAILED DESCRIPTION

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

### Notes And Conventions And Definitions

The following definitions and notes apply to terms etc. throughout this entire document and are intended to supplement as definitions and terminology for words etc. used throughout this document as if set forth in the place the word or term is used.

Handle: Although the handles herein are generally depicted as being tubular in shape, they can have other shapes in cross section as well. For instance rather than being round, they can be oval or pear shaped. Further, the cross section does not have to be the same width throughout t the length of the handle.

Plunger: The term plunger is used to designate what is pushed by the thumb at the end of the handle. It is comprised of a “button” end of some sort on which the thumb rests and presses and a shaft of some sort which extends into the handle.

Brake Pull Cord: What is referred to as a brake pull cord can be an actual cord made of various materials, including metal or metal fibers, a belt, a chain or other material which is flexible enough to go around a pulley of some sort and which is strong enough to actuate a brake. Also, it may be totally or partially contained within a sheath, such as is used in a typical mechanical bicycle brake line.

Pulley: As used herein, a pulley can be any device which allows a brake pull cord to slide over it or to rotate under it. This could be an actual pulley which has within it some sort of a bearing or merely a pin or tubular protrudence.

Note that not all of the devices either mentioned in text and/or in drawings have return springs mentioned or depicted. However, it is to be considered that each mechanism described would have some sort of return spring mechanism.

Note that although throughout this document, brakes are mentioned as actuated by a brake pull cord or similar wording, there can be embodiments where instead of the plunger push force being altered to be a pull force to actuate the brake, there can be embodiments where the push force, remains as a push force to actuate a brake or other device.

### Description Of Embodiments

Some of the various possible embodiments of a thumb actuated brake actuator, which can be used for a Lever Drive Wheelchair, as well as other wheeled mobility devices, including bicycles, are depicted in FIGS. 11, 12, 13 and 14.

FIG. 11 demonstrates in part, that the force applied by the thumb, 27, to the end of the plunger, 17, moves the plunger in direction 28. This force is transmitted via the inner shaft 25 to the flexible brake pull cord 30. The shaft 25 is attached to the brake pull cord at position 29. It must be noted that the push force at the plunger 17 needs to be converted to a pull force 27′ on the brake pull cord 30, to pull the brake cord 30, in directions 31′ and 28, with sufficient force to actuate the attached brake. Said brake could be any number of various brake types such as a caliper brake or a band brake.

Of note is that the push movement 27 is converted to a pull movement 27′ by having the brake pull cord go around a pulley 31, so that the initial direction 28 of the shaft is changed to direction 31, which in turn converts to direction 28 as the brake pull cord goes around the pulley 31.

Not that the “pulley” 31 does not have to be constructed with a bearing of some sort. It may be possible to merely have the brake pull cord go around something like a pin.

In the embodiment depicted, the handle 12, contains the shaft 25 and spring return mechanism which utilizes a spring, 24. There are various embodiments which allow for a spring type return and various embodiments as to the construction of the mechanical mechanisms which allow a push force by the thumb to be converted to a pull on the brake pull cord.

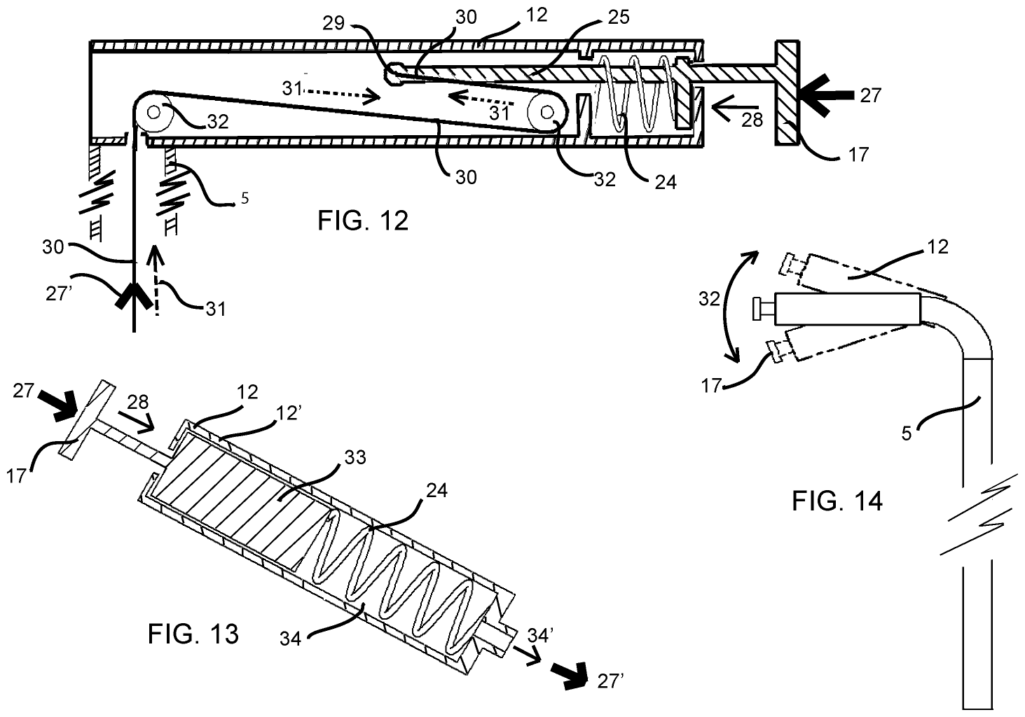

FIG. 12 depicts an embodiment of a thumb actuated brake actuator where the mechanical mechanisms are contained within the handle, 12. It provides for the push force 27 to be translated into a pull force 27′ of the brake actuator pull cord, 30, to pull in direction 31, which in the case of a Lever Drive Wheelchair, would be generally vertically upwards, with one embodiment having the brake actuator pull cord moving within the vertical lever 5, depicted in FIGS. 2, 3 and 14.

In this embodiment, FIG. 12, the push force 27 is applied to the plunger 17 which moves the plunger and the shaft, 25, in direction 28.

The shaft, 25, attaches to the brake actuator pull cord, 30, at location 29.

Movement of the plunger and shaft in direction 28, pulls the brake actuator pull cord, 30, in directions 31 as depicted, by means of going around pulleys 32 so that the resultant movement of the brake actuator pull cord is in direction 31.

Note that the “pulley” means some device which allows the brake actuator pull cord to slide around it, such as a pulley with a bearing or a pin of some sort.

In the embodiment of FIG. 12 all of the mechanical mechanisms are contained within the handle 12, including a return spring 24. However, there are various other embodiments which can provide the same process of converting the force, 27, and movement 28 to be converted to force 27 and movement 31. This includes having some of the mechanical devices at the end away from the plunger 17, including in a housing larger than would be appropriate for a handle.

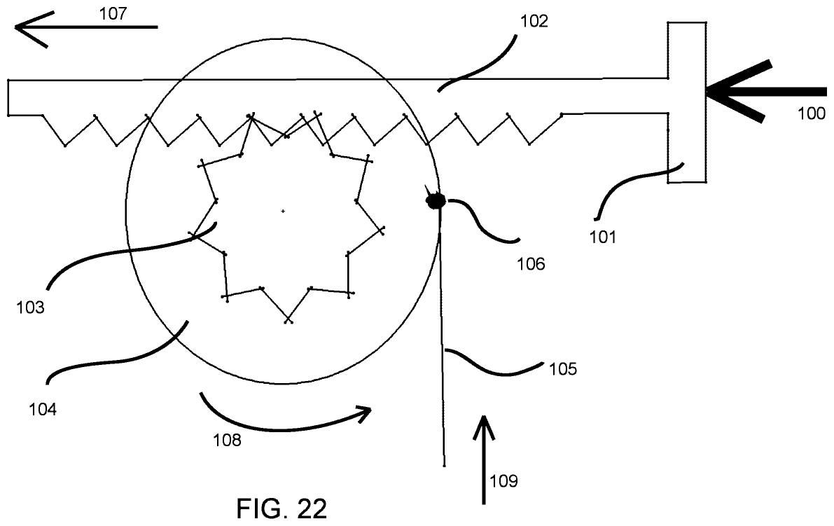

There can be an embodiment similar to that of FIG. 12, but which utilizes a rack and pinion mechanism, FIG. 22. The reversal of the thumb pushing force to a pulling force, is accomplished via a rack 102 and pinion 103, where the pinion is attached to a take up reel 104. The rack 102 essentially takes the place of the push rod, depicted in other Figures. When the “push rod”, actually the rack, moves inward in direction 107 due to force 100 on plunger 101, it rotates the pinion 104 in direction 108. Because the pinion 103 is attached to the take up reel 104, the take up reel rotates with it in direction 108. The brake pull cord 105 is attached to the take up reel 104 at location 106. So when the take up reel 104 turns and the brake cord further wraps around it, the brake pull cord 105 becomes in tension as it pulls in direction 109 and pulls on the brake. The mechanism can be housed within the handle of the Lever Drive Wheelchair, or other manual mobility device, or it can be housed at, for instance, the end opposite the plunger.

Note that by varying the diameter of the pinion and/or take up reel, various mechanical advantages can be obtained. That is, the force transmitted to the brake pull cord, can be made to be greater or lesser than the force applied to the plunger and the distance traveled by the plunger, relative to the distance moved by the brake pull cord can also be changed accordingly.

FIG. 13 is an embodiment of a thumb actuated brake actuator which uses hydraulic pressure to actuate a hydraulic type of brake.

The thumb force 27 pushes the plunger, 17, in the direction 28. The plunger 17 is either part of, or attached to a hydraulic piston, 33. The hydraulic piston 33 resides within a hydraulic cylinder 12′, all of which, in this embodiment, resides within the handle 12.

As the plunger and piston, move in direction 28, hydraulic fluid in the reservoir 34 is compressed and pushed out in direction 34′ with force 27′.

Note that in this embodiment, the return spring 24 resides within the hydraulic reservoir, but other embodiments are possible.

Note also that the force hydraulic force/pressure at 27′ can be greater or lesser than at 27, depending on the diameter of the cylinder 12′, and the piston 33.

The hydraulic fluid would run in some sort of tubing from the end of the handle to the hydraulic brake.

Note that although in this embodiment FIG. 13, all of the mechanical/hydraulic mechanisms reside in the handle. However, other embodiments include having such mechanisms in a location, for instance, housed at the opposite end from the plunger, 17. Further, this embodiment may require additional features such as valving or a different type of reservoir etc., which might be similar to items found in a typical hydraulic bicycle brake actuator.

FIG. 14 depicts that there can be various embodiments of the angle, 32, of a handle, 12, for a Lever Drive Wheelchair which is attached to the lever, 5, and which has a plunger, 17, for the thumb actuated brake actuator.

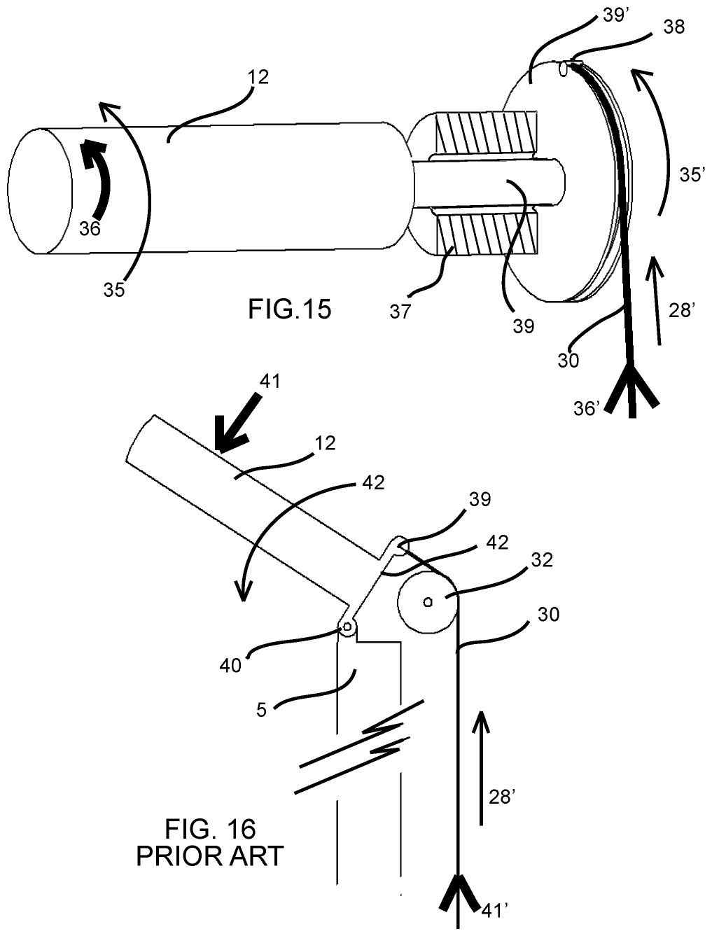

FIG. 15 is an embodiment of a brake actuator which provides for the hand to be firmly gripping the handle 12 at all times, while also actuating the brake.

To actuate the brake, the handle 12 is rotated in direction 35 which applies rotational force/torque 36 to the handle. This rotational force/torque 36 is transmitted via a shaft 39, to a take up reel 39′. The shaft can rotate within a bearing 37, which can be a various type of bearing and other than as depicted as a bushing. The brake pull cord 30 is attached to the take up reel at location 38. As the take up reel rotates in direction 35′, as a result of the rotation of the handle 12 in direction 35, the take up reel 39′ pulls the brake pull cord 30 in direction 28′ with linear force 36′.

FIG. 16 is similar to Prior Art, which is known to be utilized in in an existing Lever Drive Wheelchair design lever 5, to apply a pull force to a brake actuator cord. Reference Patent U.S. Pat. No. 8,152,188B2. See also Prior Art FIG. 5, which is excerpted from this same patent.

The design in FIG. 16 differs though from the existing design, in that the lever arm 42 can be altered in length so as to be able to apply different forces to the brake cord 30 as well as providing a method of changing the distance of rotation 42, of the handle 12 needed to apply the brake.

The handle 12 is rotated by force/torque 41 in direction 42. The handle 12 is pivoted at location 40 on the lever 5. This pivoting pulls the brake cord 30 around a pulley 32 in direction 28′ with linear force 41′ because the brake cord is attached to the lever arm 42 at location 39.

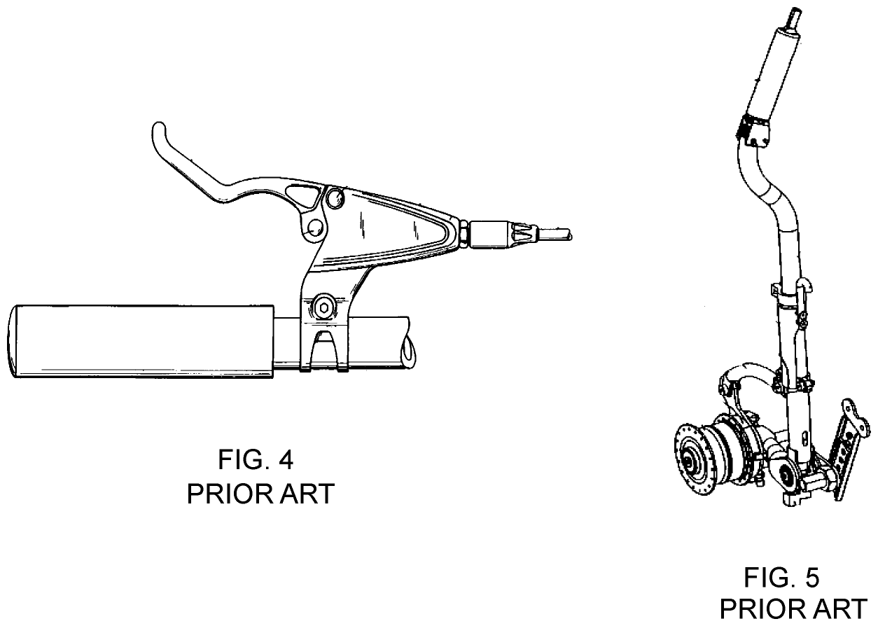

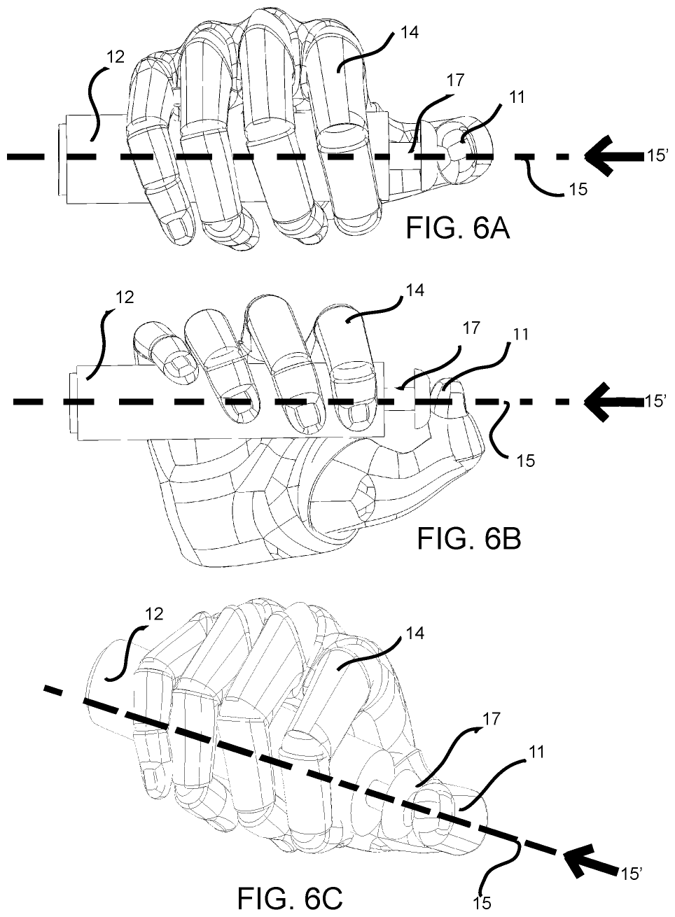

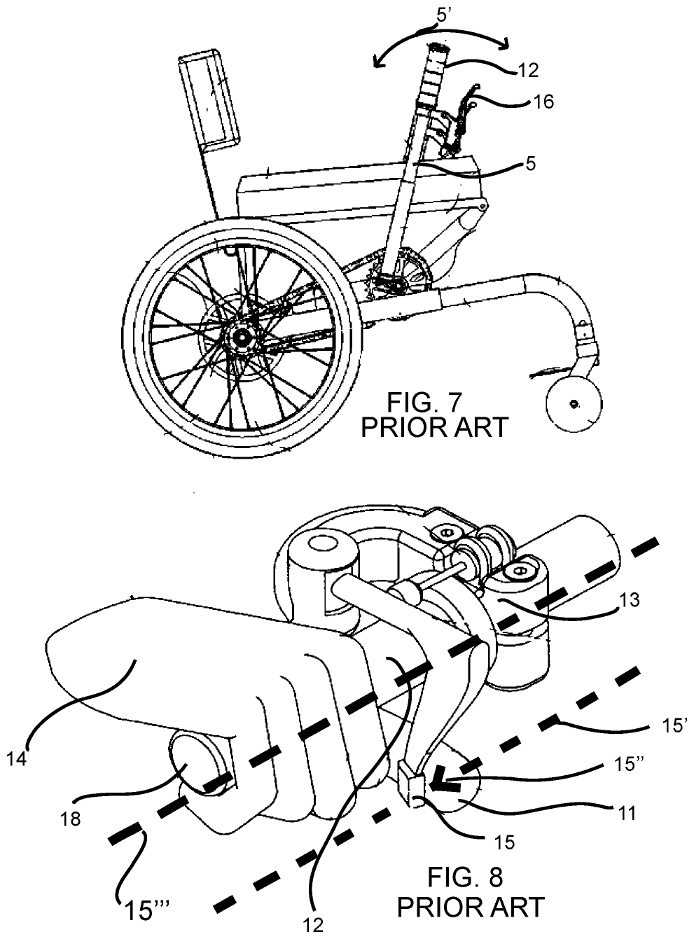

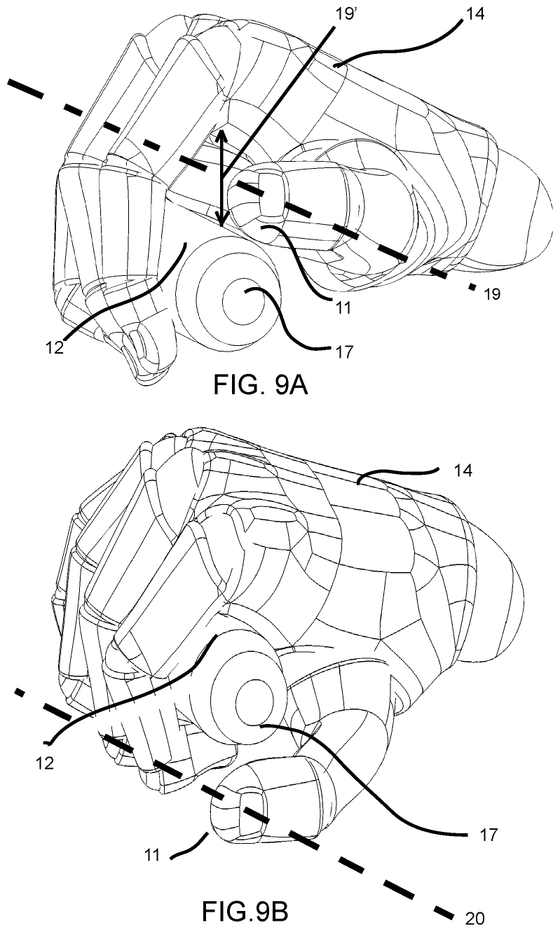

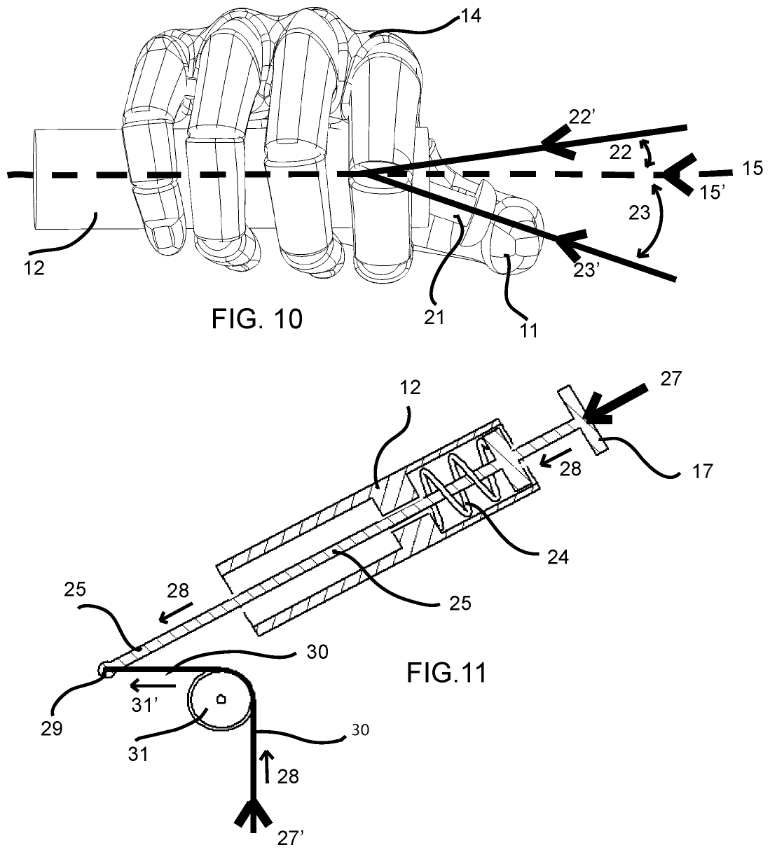

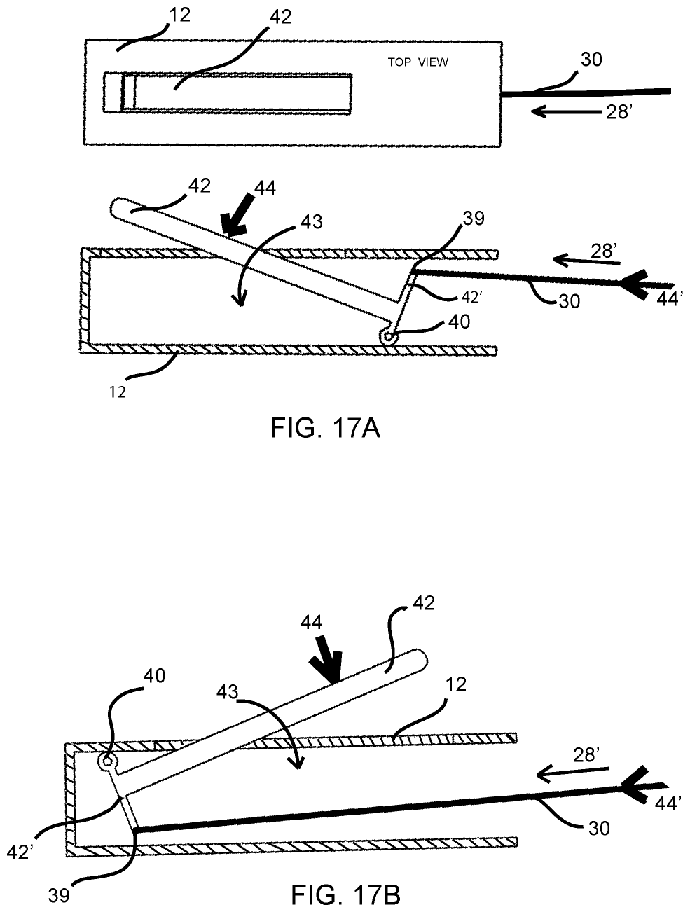

FIG. 17A represents an embodiment of a brake actuator where the user does not have to remove their fingers from the handles, in order to reach a lever to pull, such as with a typical bicycle type brake, perhaps similar to that in Prior Art FIG. 4.

In this embodiment, the lever 42 is recessed into the handle 12 but protrudes out so that a finger, or fingers can pull it inward and rotate it inward, rotation 43.

The protruding lever 42 is pressed with rotational force/torque 44 which rotates it in direction 43. The lever arm pivots at location 40. A second lever arm 42′ which is attached to lever arm 42 rotates with lever arm 42. Brake pull cord 30 is attached to lever arm 42′ at location 39. As the lever 42′ is rotated, it pulls brake cord 30 along with it in direction 28′ applying linear force 44′ to the brake actuator cord.

FIG. 17B is an embodiment which is essentially the same as the embodiment in FIG. 17A, with the difference being that the lever arm 42 is positioned in the opposite direction of the lever arm 42 in FIG. 17A. This flips the internals of the handle 12, such as pivot 4o, lever 42′ and attachment location 39, 180 degrees as depicted.

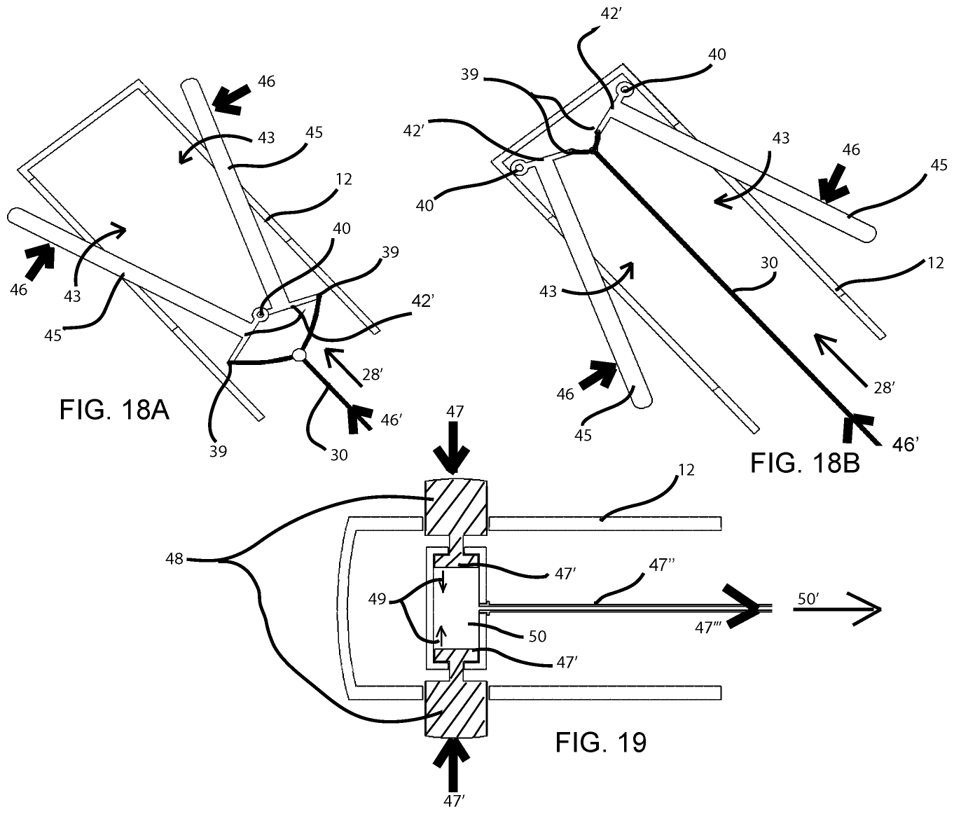

FIGS. 18A, 18B, and 19 are embodiments of brake actuators which require 2 forces be applied in order to actuate the brake. These embodiments are intended to mitigate the problem of accidently/inadvertently applying the brake of a Lever Drive Wheelchair, when forcing the lever forward or backward in the course of manually propelling the wheelchair.

Because the levers 45 are recessed into the handle 12, these embodiments are similar to FIGS. 17A and 17B which represent embodiments of a brake actuator where the user does not have to remove their fingers from the handles, in order to reach a lever to pull, such as with a typical bicycle type brake, perhaps similar to that in Prior Art FIG. 4.

For FIG. 18A, forces/torques 46 must act on both levers 45 at the same time causing rotations 43. In this embodiment, the levers pivot at location 40 which rotates levers 42′. Because the brake actuator cord is attached at locations 39, when lever 42′ rotates, it pulls the brake cord 30 along with it in direction 28′ with associated linear force 46′.

FIG. 18B is in essence similar to that of FIG. 18A in the mode of operation. The difference is that the handles 45 are flipped 180 degrees, as depicted, and the pivots 40 are relocated as shown.

FIG. 19 is a brake actuator which uses hydraulic pressure to actuate a hydraulic brake. This embodiment requires that two forces be applied, 47 and 47′ to actuate the brake.

Forces 47 and 47′ push in two plungers 48 located in the handle 12, which then push in two pistons 47′ which are inside of a hydraulic cylinder, in direction 49. The pistons compress the hydraulic fluid 50 so that it pressurizes a tube 47″ with pressure 47′″ which pushes the hydraulic fluid 50 to the hydraulic brake in direction 50′ with pressure 47′″.

This embodiment may require additional features such as valving or a different type of reservoir etc., which might be similar to items found in a typical hydraulic bicycle brake actuator.

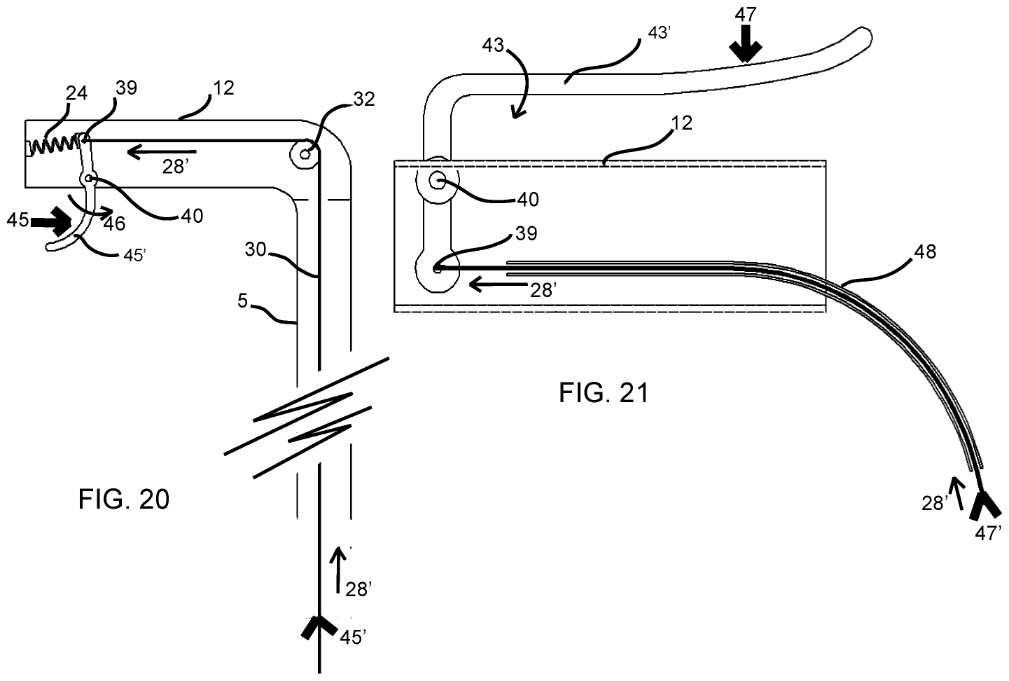

FIG. 20 is an embodiment of a brake actuator, which might be called a trigger actuated brake actuator.

There currently exists add on trigger like devices for bicycles, to either aid in shifting or to apply brakes. However, such add on devices sit outside of the handlebars and handle and utilize cords which must go outside of the handlebars on their way to a shift mechanism or brake.

The embodiment in FIG. 20 houses the mechanism inside of the handle 12 and the brake pull cord can travel within the handle and the lever 5 of a Lever Drive Wheelchair or other human mobility device.

The trigger like mechanism 45′ is pressed with a thumb or finger with force/torque 45. This rotates the mechanism 45′ in direction 46 as it pivots about the pivot located at location 40. The brake pull cord 30 is attached at location 39 which get pulled in direction 28′. The brake pull cord transitions around pulley 32 to a vertical direction down the lever 5 to the brake and pulls the brake pull cord in direction 28′ with linear force 45′. Item 24 is a return spring.

FIG. 21 is an embodiment similar to a conventional ad on bicycle brake handle, such as depicted in Prior Art FIG. 4 excerpted from Patent No. U.S. Pat. No. 5,950,772. However, in this embodiment, the actuation mechanism is contained within the handle 12 unlike as depicted in Prior Art FIG. 4 where all of the mechanism and the brake pull cord itself is outside of the handle and handlebar.

The embodiment in FIG. 21 allows fingers to travel a minimum of distance to access the lever 43′.

The lever 43′ is pressed with force/torque 47 which rotates the lever 43′ in direction 43. The lever is pivoted at location 40. The brake pull cord is attached at location 39 and is pulled in direction 28′ with linear force 47′. The brake pull cord can be similar to a conventional bicycle brake type housed within a sheath 48.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A brake actuator mechanism for a human mobility device, comprising:
at least one lever having a handle;
a transmission coupled to at least one lever and one or more wheels; wherein movement of the at least one lever drives rotation of the one or more wheels;
a brake connected to the one or more wheels and configured to apply a braking force to the one or more wheels; and,
a brake actuator mechanism comprising a plunger located at an end of the handle; wherein the plunger is configured to move into the end of the handle to actuate the brake and move out of the handle to disengage the brake, and wherein the plunger is positioned such that when a user grasps the handle, a thumb of the user may actuate or disengage the plunger.

2. The brake actuator mechanism of claim 1, wherein the human mobility device is a wheelchair.

3. The brake actuator mechanism of claim 2, wherein the at least one lever further comprises a first lever having a first handle and a second lever having a second lever; wherein the first lever and the second lever are both connected to a transmission.

4. The brake actuator mechanism of claim 1, wherein the plunger further comprises a spring return mechanism.

5. The brake actuator mechanism of claim 1, further comprising a pull cord or hydraulic line.

6. The brake actuator mechanism of claim 1, further comprising an inner shaft connected to the plunger and positioned within the handle and/or the lever, and a pull cord connected to the inner shaft, and wherein the brake actuator mechanism is further configured to convert an inward push movement of the plunger and inner shaft into an outward pull movement of the pull cord.

7. The brake actuator mechanism of claim 6, further comprising a pulley or pin over which the pull cord is positioned.

8. The brake actuator mechanism of claim 1, wherein a portion of the thumb of the user between an end of the thumb and a thumb interphalangeal joint may actuate or disengage the plunger.

9. The brake actuator mechanism of claim 1, further comprising a first pulley and a second pulley both located within the handle and/or lever; wherein a pull cord is positioned around the first pulley and the second pulley so as to convert an inward pushing movement of the plunger into a pulling force on the pull cord.

10. The brake actuator mechanism of claim 1, wherein the plunger is connected to a hydraulic piston within a hydraulic cylinder within the handle, wherein inward movement of the hydraulic piston is configured to actuate the brake.

11. A brake actuator mechanism for a human mobility device, comprising:
at least one lever having a handle rotatably connected to the at least one lever;
a transmission coupled to at least one lever and one or more wheels; wherein movement of the at least one lever drives rotation of the one or more wheels;
a brake connected to the one or more wheels and configured to apply a braking force to the one or more wheels; and,
a brake actuator mechanism comprising a pull cord coupled to the handle such that rotation of the handle actuates the brake.

12. A brake actuator mechanism for a human mobility device, comprising:
at least one lever having a lever handle;
a transmission coupled to at least one lever and one or more wheels; wherein movement of the at least one lever drives rotation of the one or more wheels;
a brake connected to the one or more wheels and configured to apply a braking force to the one or more wheels; and,
a brake actuator mechanism comprising a brake handle extending outward from a recess into the lever handle; wherein the brake handle is pivotally mounted and pivotal movement of the brake handle actuates the brake.
